(19) United States
(12) Patent Application Publication
(10) Pub. No.: US 2007/0043851 A1
(43) Pub. Date: Feb. 22, 2007

(54) FACILITATING A USER TO DETECT DESIRED ANOMALIES IN DATA FLOWS OF NETWORKS

(75) Inventors: Venkata Siva Kiran Yellamraju, North Guwahati (IN); Parag Narayanrao Pote, Bangalore (IN)

Correspondence Address: LAW FIRM OF NAREN THAPPETA, C/O LANDON IP, INC., 1700 DIAGONAL ROAD, SUITE 450, ALEXANDRIA, VA, 22314, US

(73) Assignee: NETDEVICES, INC., Sunnyvale (US)

(21) Appl. No.: 11/161,759

(22) Filed: Aug. 16, 2005

(51) Int. Cl. G06F 15/173

(52) U.S. Cl. 709/224

(57) ABSTRACT

A detection system in which a user can indicate the permissible sequences of packets (e.g., by virtue of a state transition table), and the detection system detects packets which are inconsistent with such permissible sequences. As a result, all anomalies (which are inconsistent with the user specified normal behavior) may be reliably detected.

### BACKGROUND OF THE INVENTION

1. Field of the Invention

The present invention relates generally to inter-networking environments, and more specifically to a method and apparatus to detect anomalies in data flows of networks.

2. Related Art

There is a recognized need to detect anomalies in data flows of networks. For example, in various network security applications such as firewalls, virus detection software, intrusion detection systems, etc., attempt is made to detect (sequence of) packets, which would cause undesirable results.

According to one approach, such detection attempts are hard-coded into the software instructions (of potentially the base applications, such as SMTP mail or firewall). That is, a vendor (designer) of the software implements the product to detect anomalies based on known criteria (e.g., the content of the sequence of packets causing the undesirable results is known).

One problem with such an approach is that new anomalies cannot be detected due to the hard coding of the corresponding detection logic. In addition, such applications are specifically tailored for corresponding environments and do not scale to address new environments/challenges.

Signatures based approaches overcome such a problem in some type of applications (e.g., virus software and intrusion detection systems). Signatures generally indicate data patterns that are (a priori) known to be generated by malicious parties to cause a corresponding undesirable result (e.g., a security threat in a network).

Thus, a device periodically updates the signatures and matches the received packets (of data flows) against the signatures to detect the corresponding anomalies. However, such an approach also is suited for specific applications and does not provide a user the flexibility of addressing any new types of desired applications.

Accordingly what is needed is a more flexible method and apparatus, which facilitates a user to detect desired anomalies in data flows of networks.

### BRIEF DESCRIPTION OF THE DRAWINGS

The present invention will be described with reference to the accompanying drawings, which are described below briefly. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an example environment in which various aspects of the present invention can be implemented.

FIG. 2 is a flowchart illustrating the manner in which anomalies in packet flows can be detected in an embodiment of the present invention.

FIGS. 3A-3C together illustrate an example convention by which permissible states and packet contents can be defined for a protocol of interest.

FIG. 4 is a state transition diagram for an example protocol.

FIGS. 5A-5D together define the configuration data for the protocol of FIG. 4 in one embodiment.

FIG. 6 is a block diagram illustrating the details of an embodiment of a digital processing system in which various aspects of the present invention are operative by execution of appropriate software instructions.

### DETAILED DESCRIPTION OF THE PREFERRED EMBODIMENTS

### 1. Overview and Discussion of the Invention

An aspect of the present invention enables a user to specify permissible sequences of packets for a protocol, and detects anomalous packets by determining whether a sequence of received packets is consistent with the specified permissible sequences. If the received packets are not consistent with the permissible sequences, an anomaly is deemed to be detected. Once the anomalous behavior is detected, any desired action (e.g., logging, reporting, dropping) can be performed consistent with the requirements of the specific environment.

As a result, the user can detect anomalies with respect to new protocols, as well as previously unforeseen anomalies. The protocols can be at any desired level (e.g., application layer).

In an embodiment, the definition of permissible sequences (including a start state) is modeled according to a state machine, which indicates acceptable states for a protocol, a set of acceptable inputs (i.e., acceptable packet contents when at that state) at each acceptable state, and a next state corresponding to a combination of an acceptable state and a corresponding input.

Thus, an implementation maintains a present state, with the present state being set to the start state initially. When a packet is received, the content of the packet is examined to determine whether the content forms an acceptable input for the present state. If the content is not an acceptable input for the present state, an anomaly is deemed to be detected. If the content is an acceptable input, the next state is determined for the combination of the present state and the input. The processing of packets thus continues with the present state being set to the next state.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### 2. Example Environment

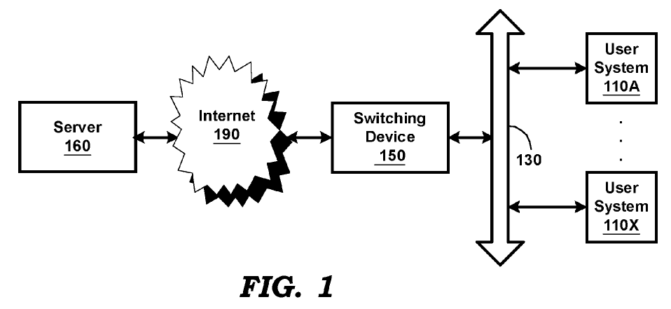

FIG. 1 is a block diagram illustrating the details of an example environment in which various aspects of the present invention can be implemented. The environment is shown containing user systems 110A-110X, local-area-network (LAN) 130, switching device 150, server 160 and Internet 190. For illustration, it is assumed that user systems 110A-110X, and LAN 130 are located within an enterprise. Each block is described in further detail below.

User systems 110A-110X represent devices, which can be used to access various data and services (e.g., on server 160) using Internet 190 via LAN 130. Internet 190 contains various routers/gateways which enable communication between systems on the world-wide-web and user systems 110A-110X using Internet Protocol, in a known way. LAN 130 may also be implemented using IP (and Ethernet), and provide communication between user system, as well as with external systems.

Switching device 150 forwards packets from one interface to other, and also implements various services (e.g., firewall, intrusion detection system). In embodiment(s) described below, switching device 150 is assumed to operate consistent with Internet Protocol (IP) and thus the interface on which the packet is forwarded, depends on the destination IP address of the packet.

Being in the path of packets going in/out of the enterprise, it may be desirable to detect anomalous packets (which could cause undesirable results) within switching device 150. Various aspects of the present invention enable such detection as described below in further detail.

### 3. Detecting Anomalous Packets

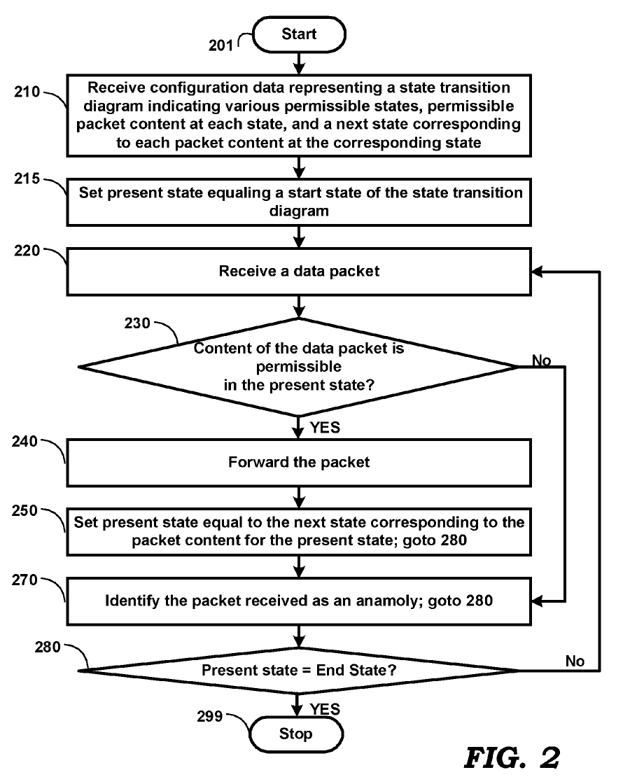

FIG. 2 is a flowchart illustrating the manner in which packets for a protocol are processed in a switching device while detecting anomalous packets in an embodiment of the present invention. The flowchart is described with reference to FIG. 1 merely for illustration. However, the various features can be implemented in other devices/environments as well. The flowchart starts in step 201, in which control passes to step 210.

In step 210, switching device 150 receives data representing a state transition diagram for a protocol, indicating various permissible states (including a start state, permissible packet content at each state, and a next state corresponding to each packet content at the corresponding state.

It should be appreciated that the state transition diagram indicates the permissible sequences of packets for the protocol, and also that the protocol can be at any desired level (e.g., at application layer) consistent with the requirements of the specific environment. In addition, multiple state transition diagrams may be used if multiple protocols are of interest.

In step 215, switching device 150 sets the present state (a variable) to equal the start state. In step 220, switching device 150 receives a data packet (consistent with the protocol of step 210).

In step 230, switching device 150 determines whether the content of the data packet is permissible in the present state according to the protocol definition. The data of step 210 is used to determine whether the content is permissible. If the content is permissible (i.e., permitted by the protocol), control passes to step 240, and to step 270 otherwise.

In step 240, switching device 150 may forward the packet since the packet is permitted by the protocol. In step 250, switching device 150 sets the present state equal to the next state corresponding to the packet content for the present state and the data content determined in step 230 (according to the data of step 210). Control then passes to step 280.

In step 270, switching device 150 identifies the packet received as an anomaly. Though not shown, various actions (e.g., logging the packet and state information, dropping the packet) may be performed when the anomaly is detected. Control then passes to 280.

In step 280, switching device 150 determines whether the present state equals an End state. If it is an end state, the processing of packets stops in step 299, otherwise control is transferred to step 220 for processing additional packets.

Thus, due to the use of the approach (es) described above, all the anomalous packets may be accurately detected. Also, the state transition diagram can be represented using various conventions. The description is continued with respect to an example convention, as well as its use in an example context.

### 4. Convention for Representing State Transition Diagram

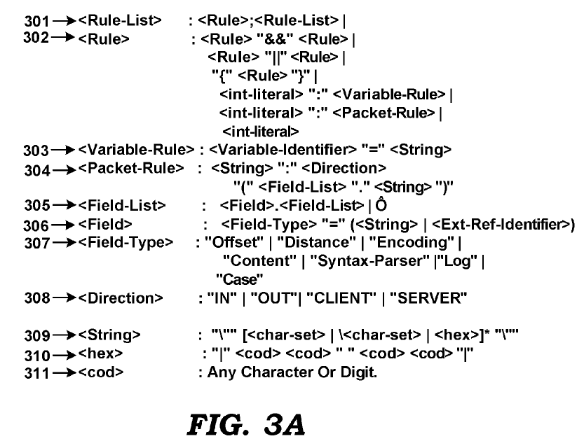

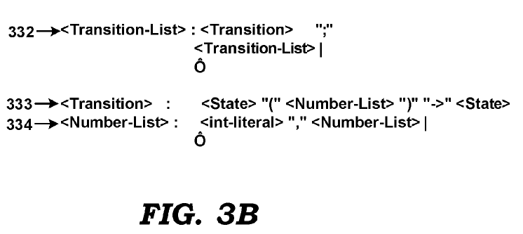

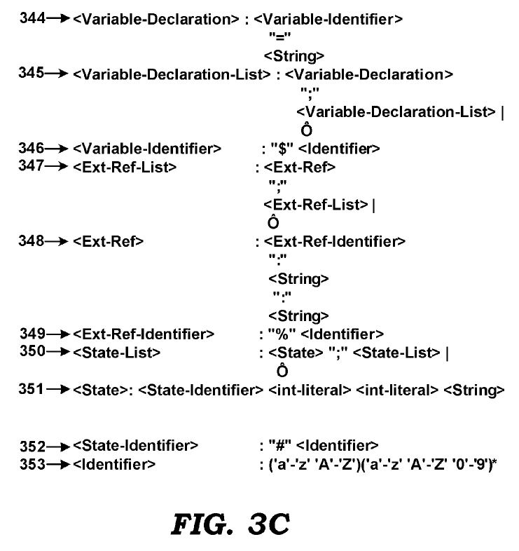

Broadly, the convention needs to provide for definition of various permissible packet contents (at the present state) and the consequent state transitions, consistent with the specific protocol for which an implementation is being designed. FIG. 3A illustrates depict example convention for specifying the packet content, and FIG. 3B contains an example convention for depicting state transitions, as described briefly below in further detail.

With respect to FIG. 3A, block 301 provides that a rule list contains rules (specifying corresponding packet contents sought to be matched later when processing packets) separated by the character ‘;’. Block 302 defines specifically how a rule in turn can be defined. As may be noted rules are generated from logical AND conditions (&&), OR conditions (II), a pre-defined rule enclosed in brackets, variable-rule identified by a unique identifier (int-literal), a packet-rule again identified by a unique identifier, or by an identifier already defined), etc.

Block 303 specifies how a variable-rule can be defined. In particular, it is indicated that a variable-identifier is set equal to a string. Block 304 specifies how a packet-rule (i.e., content) can be defined. In particular, the rule contains an identifier string, information on the direction of packet flow (defined in block 308) and the specific content using field-list.

Block 305 specifies that field-list contains one or more fields separated by the character Block 306 specifies that each field is defined as a field-type equaling either a string or a ext-ref-identifier. The field type can be one of offset (e.g., from the beginning of the location at which the protocol specific content begins in a received packet), distance, encoding (the mode of encoding), content (sought to be matched), syntax-parser (described below), log, case, as specified in block 307.

The field-type generally is of one the forms (offset, distance, content) when the packet format is static and the desired packet content can be identified at a pre-specified offset. On the other hand, when extensive parsing is required, a user may be provided the option of specifying a program logic (e.g., C code), which returns the packet content of interest from the packet. Alternatively, the program logic may return a true/false result indicating whether the desired packet content was present (matched) or not.

For example, assuming for simplicity that a string “hello” is a desired content, an external procedure (hello.h) is specified according to the ext-ref-list of line 347 as follows (in which hello.h is the header file containing the definition of the procedure hello_method):

% hello: “./hello.h”:“hello_method”

A Rule for this packet may be defined as:

18: “Hello Packet” : IN ( Syntax-Parser = %hello . “ ” );
The hello_method may be defined in a hello.c file as follows:
bool hello_method(Packet *pkt)
{
/* any desired logic to return the desired result */
}

Thus, when a packet match needs to be determined according to the above rule, the “hello_method” procedure (defined in hello.c and hello.h) is executed to return a value which can be used to determine the next state. This procedure can be used to do any complicated and/or protocol specific processing on the packet where simple string operations will not suffice (example: decoding etc.)

Continuing with reference to FIG. 3A, Block 308 indicates that the direction of packet can be one of in, out, client and server. The in and out are intended to represent different directions of packets in a packet flow. Similarly, client indicates that the packet is received from a client side of the application, and server indicates that the packet is received from the server side.

Blocks 309, 310 and 311 together specify the manner in which a string can be defined.

Continuing with reference to FIG. 3B, blocks 332-334 illustrate the manner in which state transitions can be defined. In particular, block 332 specifies that a transition list contain one or more transitions. Block 333 specifies that a transition is identified by (present) state, a number-list (which identifies the desired packet content(s)), and (next) state.

From the above convention, a user may specify the permissible packet content (inputs) at each state, and the corresponding next states. It may be further desirable that a user specifies additional conditions with respect to detecting anomalies and desired actions in such cases. FIG. 3C illustrates the manner in which such objectives may be achieved.

Block 344 specifies that a variable-declaration is defined as a variable-identifier (unique number) equaling a string. Block 345 specifies that a variable-declaration-list contains one or more variables separate by the character ‘;’. Block 346 indicates that a variable-identifier is defined by a ‘$’ character followed by a unique identifier. Though not illustrated with example, the variables can be used, for example, to conditionally control various actions, and can be changed by the program or set by a user (using a suitable interface).

Blocks 347-349 together specify the manner in which a user can specify external program logic for determining a desired packet content. Thus, block 347 specifies that the ext-ref-list contains one or more ext-ref (external references) separated by the character ‘;’. Block 348 specifies that the ext-ref is specified by a unique identifier (ext-ref-identifier) followed by two strings (the second string indicating the procedure which is to be executed, and the first string indicating the header file which contains the definition of the procedure). Block 349 specifies that ext-ref-identifier is defined by the character ‘%’ followed by a unique identifier.

Block 350 indicates that the state-list contains one or more states separated by the character ‘;’ Blocks 351-353 together specify the definition of each state, in addition to the manner in which a user may specify additional conditions upon which an anomaly should be detected. Block 351 specifies that a state is defined by a state-identifier followed two int-literals (numbers) and a string.

The first number indicates a timeout value and the second number indicates the maximum permissible number of occurrences of the state while processing packets in a single instance of the state machine (for a single transaction of the application in the described embodiments). Once the state is reached that many times, the associated string may be logged in a log file (or otherwise made available for debugging). Blocks 352 and 353 specify the manner in which state identifier can be defined.

The conventions described above can be used to represent the state transition diagrams for various applications as described below with reference to an example. It should be appreciated that the techniques/approaches described above can be extended as suited for specific protocols and implementations.

### 5. Example Protocol to be Modeled

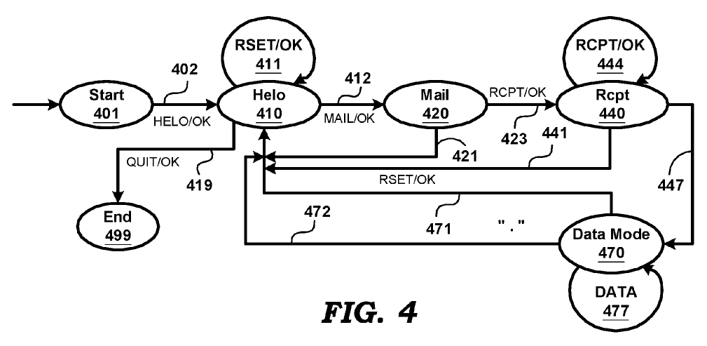

FIG. 4 contains a state diagram illustrating the details of a protocol for which anomalous packets can be detected in an embodiment of the present invention. For ease of understanding, a small subset of the SMTP protocol is depicted there. However, extending the approaches/techniques described herein to complex protocols will be apparent to one skilled in the relevant arts by reading the disclosure provided herein.

The state diagram is shown containing start state 401. Initially, the present state is set to the Start state. After a HELO packet is sent in one direction and a OK packet is received, the present state transitions to Helo state 410 as shown by link 402. In Helo state 410, a RSET packet and OK response may be received several times as shown by loop 411. A QUIT packet and OK response in Helo state 410, would cause a transition to End state 499 (in which the state machine ends) as shown by link 419. A MAIL packet followed by a OK response would cause a transition to mail state 420 as depicted by link 412.

In mail state 420, the present state transitions to Rcpt state 440 upon receiving a RCPT packet and a OK response, as depicted by link 423. Similarly, Helo state 410 is reached from each of mail state 420, Rcpt state 440, and date mode state 470 upon receiving RSET packet followed by OK response, as shown by links 421, 441 and 471 respectively.

In Rcpt state 440, the present state transitions to Data Mode 470 upon receiving data packet followed by OK response. In data mode state 470, the present state transitions to Helo state 410 upon receiving a “.” character, as depicted by link 472.

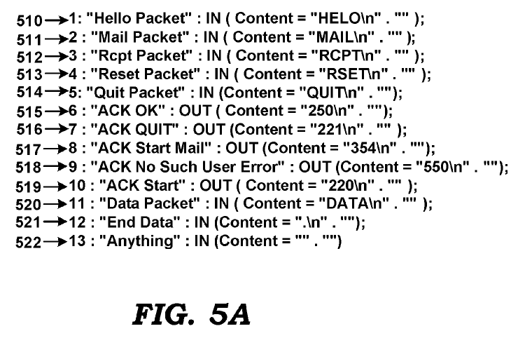

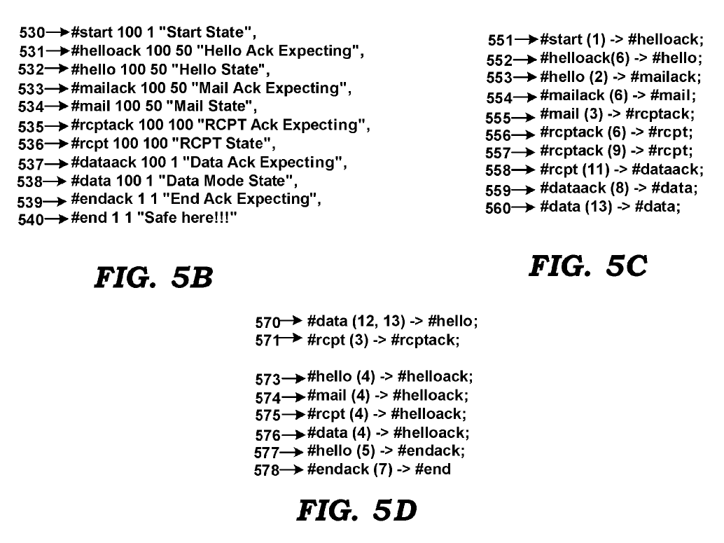

The above state transition diagram can be represented in a configuration file as described below with respect to FIGS. 5A-5D.

### 6. Configuration File

FIG. 5A contains a portion of the configuration file illustrating the manner in which a user may define various packet contents of interest (consistent with the grammar of FIG. 3A). Each line contains unique identifier (number), a descriptive text, the packet direction, and the specific content of interest. Individual lines are described briefly below.

Lines 510-522 respectively contain identifiers 1-13 and are designed to match the content HELO (link 402), MAIL (link 412), RCPT (link 423), RSET (links 421, 441 and 471), QUIT (link 419), 250 (OK of link 411), 221 (OK of link 419), 354 (OK of link 412), 550 (indicating error in mail identifier, in link 412), 220 (OK of link 402), DATA (link 447), character ‘.’ (link 472), and NULL value (matching anything).

FIG. 5B contains a portion of the configuration file illustrating the manner in which a user may define permissible states (consistent with the grammar of FIG. 3C and the states of FIG. 4), in addition to the number of times the corresponding state may be reached in a desired duration. Thus, line 530 indicates that the start state can be reached only once in 100 time units and the message to be logged equals “Start State” if this rule is violated.

Each state of FIG. 4 is shown as two (sub)states, corresponding to a sent packet and the ack expected. Thus, lines 532, 534, 536, 538, and 540 respectively define Helo state 410, mail state 420, Rcpt state 440, data mode state 470 and End state 499, and the corresponding intermediate states (waiting for ack) are represented by lines 531, 533, 535, 537, and 539.

FIGS. 5C and 5D together contains a portion of the configuration file illustrating the manner in which state transitions can be represented in response to receiving the corresponding packet content. Thus, lines 551 and 552 correspond to link 402, lines 553 and 554 correspond to link 412, lines 555 corresponds to link 423, lines 558 and 559 correspond to link 447, line 560 corresponds to link 477, lines 570 correspond to link 472, lines 571, 556 and 557 correspond to 444, lines 577 and 578 together corresponds to link 419, and lines 573-576 respectively corresponds to links 411, 421, 441 and 471.

From the above, it may be appreciated that a user may use the configuration data of FIGS. 5A-5D to specify permissible sequences of packets, and the anomalies are detected by examining the packets. The description is continued with respect to an operation details.

### 7. Operation Example

The operation of switching device 150 is described with reference to the above configuration data. Thus, a user may provide the configuration data either in the form of a configuration file or over a network by using a suitable interface. Switching device 150 scans or examines the packets according to the configuration file.

In general, the anomalies can be detected in the data packet flows for any protocol level (application level in the above example). Switching device 150 needs to first establish that each packet relates to the protocol before applying the rules specified by the user. A separate instance of the state machine may be maintained for each transaction (set of related packet flows), and the state machine terminates according to the end state specified in the configuration data. For example, each instance of SMTP client contacting a SMTP server may cause of a corresponding instance of the state machine to be maintained.

In addition, switching device 150 may maintain various counters and timers to support the feature of counting the number of times a state is reached in a specified time duration. Such a feature may be conveniently used to identify various anomalies. For example, rule 536 of FIG. 5B may detect a situation in which the number of recipients exceeds 100.

While various features of the present invention are described above with reference to a switching device, it should be appreciated that features can be implemented in other devices (e.g., protocol monitoring devices) also without departing from the scope and spirit of several aspects of the present invention. It should also be appreciated that the features described above may be implemented in various combinations of hardware, software and firmware, depending on the corresponding requirements. The description is continued with respect to an embodiment in which the features are operative upon execution of the corresponding software instructions.

### 8. Software Implementation

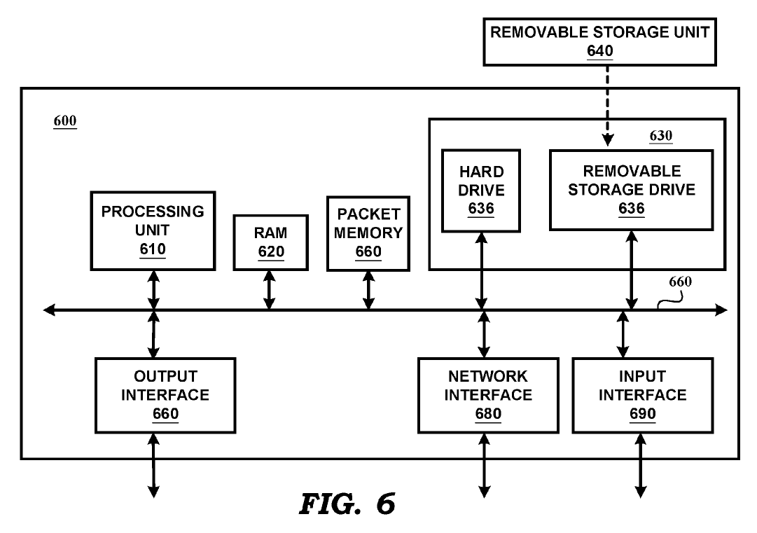

FIG. 6 is a block diagram illustrating the details of digital processing system 600 in one embodiment. System 600 may correspond to switching device 150. System 600 is shown containing processing unit 610, random access memory (RAM) 620, secondary memory 630, output interface 660, packet memory 670, network interface 680 and input interface 690. Each component is described in further detail below.

Input interface 690 (e.g., interface with a key-board and/or mouse, not shown) enables a user/administrator to provide any necessary inputs to system 600. Output interface 660 provides output signals (e.g., display signals to a display unit, not shown), and the two interfaces together can form the basis for a suitable user interface for an administrator to interact with system 600.

Network interface 680 may enable system 600 to send/receive data packets to/from other systems on corresponding paths using protocols such as internet protocol (IP). Network interface 680 may logically contain several physical interfaces of different mediums (e.g., T1, Ethernet, T3), with packets received on one physical interface being forwarded on another physical interface. Network interface 680, output interface 660 and input interface 690 can be implemented in a known way.

RAM 620, secondary memory 630, and packet memory 670 may together be referred to as a memory. RAM 620 receives instructions and data on path 650 (which may represent several buses) from secondary memory 630, and provides the instructions to processing unit 610 for execution.

Packet memory 670 stores (queues) packets waiting to be forwarded (or otherwise processed) on different ports/interfaces. The packets in the queues may be examined to determine the anamolous packets for the corresponding protocol (according to various aspects of the present invention), and the appropriate action may be performed. Suitable interfaces may be evolved with corresponding services (NAT, firewall, intrusion detection system) being implemented in case the device corresponds to a switching device, and the protocols may perform any desired operation, as well.

Secondary memory 630 may contain units such as hard drive 635 and removable storage drive 637. Secondary memory 630 may store the software instructions and data (including the configuration data described above), which enable system 600 to provide several features in accordance with the present invention. Some or all of the data and instructions may be provided on removable storage unit 640 (or from a network using protocols such as Internet Protocol), and the data and instructions may be read and provided by removable storage drive 637 to processing unit 610. Floppy drive, magnetic tape drive, CD-ROM drive, DVD Drive, Flash memory, removable memory chip (PCMCIA Card, EPROM) are examples of such removable storage drive 637.

Processing unit 610 may contain one or more processors. Some of the processors can be general purpose processors, which execute instructions provided from RAM 620. Some can be special purpose processors adapted for specific tasks (e.g., for memory/queue management). The special purpose processors may also be provided instructions from RAM 620. In general, processing unit 610 reads sequences of instructions from various types of memory medium (including RAM 620, storage 630 and removable storage unit 640), and executes the instructions to provide various features of the present invention described above.

### 9. CONCLUSION

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method of detecting anomalous packets received according to a protocol having a definition of permissible sequences of packets, said method being performed in a device, said method comprising:
enabling a user to specify said permissible sequences of packets as a configurable data;
receiving a plurality of packets according to said protocol;
determining whether said plurality of packets are consistent with said definition of permissible sequences; and
concluding that an anomaly is detected if said plurality of packets are not consistent with said definition of permissible sequences specified as said configurable data.

2. The method of claim 1, wherein said protocol comprises an application layer protocol.

3. The method of claim 1, wherein said configurable data represents a state machine containing a set of states, permissible packet content in each state, and a next state corresponding to each permissible content for a state, wherein said packet content is defined to be contained in packets received by said device.

4. A method of processing packets in a device, said method comprising:
enabling a user to provide data indicating a plurality of acceptable states for a protocol, a set of acceptable inputs at each of said plurality of acceptable states, and a next state corresponding to a combination of a first acceptable state and a corresponding input, wherein said next state and said corresponding input are respectively comprised in said plurality of acceptable states and said set of acceptable inputs, and each acceptable input corresponds to a packet according to said protocol with a corresponding content;
receiving a first packet according to said protocol when in a present state, wherein said present state is contained in said plurality of acceptable states;
examining the content of said first packet to determine whether the content of said first packet forms an acceptable input for said present state; and
determining that receiving said first packet is an anomaly if the content of said first packet does not form said acceptable input for said present state.

5. The method of claim 4, wherein said configurable data is provided in a configuration file.

6. The method of claim 4, further comprising enabling said user to specify a desired action when said anomaly is determined.

7. The method of claim 6, wherein said action comprises logging information related to said first packet and said present state in a log.

8. The method of claim 6, wherein said device comprises a switch, wherein said desired action comprising dropping said first packet.

9. The method of claim 8, further comprising forwarding said first packet if said anomaly is determined not to be present.

10. The method of claim 4, wherein said configuration data contains an offset value and a content value, wherein said examining compares data in said first packet at said offset value with said content value to determine whether said anomaly is present.

11. The method of claim 10, wherein said configuration data contains a user defined program logic to determine the data in said first packet to be compared if said first packet is defined according to a format by which the location of desired fields vary.

12. The method of claim 10, wherein said configuration data specifies a time out duration, a second action and a count associated with a second state, wherein said second action is performed if said second state is reached count number of times.

13. The method of claim 4, further comprising:
setting said present state to equal a next state corresponding to the combination of said present state and said content of said first packet if the content of said first packet forms said acceptable input; and
performing said receiving, said examining and said determining.

14. The method of claim 4, wherein said protocol comprises an application layer protocol.

15. A computer readable medium carrying one or more sequences of instructions for causing a network device to detect anomalous packets received according to a protocol having a definition of permissible sequences of packets, wherein execution of said one or more sequences of instructions by a plurality of processors contained in said network device causes said one or more processors to perform the actions of:
enabling a user to specify said permissible sequences of packets as a configurable data;
receiving a plurality of packets according to said protocol;
determining whether said plurality of packets are consistent with said definition of permissible sequences; and
concluding that an anomaly is detected if said plurality of packets are not consistent with said definition of permissible sequences specified as said configurable data.

16. The computer readable medium of claim 15, wherein said configurable data represents a state machine containing a set of states, permissible packet content in each state, and a next state corresponding to each permissible content for a state, wherein said packet content is defined to be contained in packets received by said device.
